(19) United States
(12) Patent Application Publication
(10) Pub. No.: US 2025/0256255 A1
(43) Pub. Date: Aug. 14, 2025

(54) SYSTEM FOR THE NEUTRAL/NEGATIVE CO2 PRODUCTION OF SYNGAS FROM SOLID FUELS WITH HIGH HYDROGEN CONTENT FOR USES AT HIGH TEMPERATURE

(71) Applicants: WALTER TOSTO S.P.A., Chieti (CH) (IT); UNIVERSITÀ DEGLI STUDI DELL'AQUILA, L'Aquila (AQ) (IT); UNIVERSITA' DEGLI STUDI GUGLIELMO MARCONI, Roma (RM) (IT)

(72) Inventors: Andrea DI CARLO, L'Aquila (IT); Enrico BOCCI, Roma (IT); Pier UGO FOSCOLO, L'Aquila (IT); Elisa SAVUTO, L'Aquila (IT); Luca DEL ZOTTO, Roma (IT)

(73) Assignees: WALTER TOSTO S.P.A., Chieti (CH) (IT); UNIVERSITÀ DEGLI STUDI DELL'AQUILA, L'Aquila (AQ) (IT); UNIVERSITA' DEGLI STUDI GUGLIELMO MARCONI, Roma (RM) (IT)

(21) Appl. No.: 18/856,939

(22) PCT Filed: Apr. 17, 2023
(86) PCT No.: PCT/IT2023/050103

§ 371 Date: Oct. 15, 2024

(30) Foreign Application Priority Data
Apr. 15, 2022 (IT) 102022000007613

(51) Int. Cl. B01J 8/26; B01D 46/24; B01D 53/02; B01J 8/00; B01J 8/02; B01J 8/06; B01J 8/18; C01B 3/02; C10J 3/54; C10J 3/56

(52) U.S. Cl. CPC B01J 8/26; B01D 46/2407; B01D 53/02; B01J 8/0055; B01J 8/006; B01J 8/0257; B01J 8/065; B01J 8/1836; C01B 3/02; C10J 3/54; C10J 3/56; B01D 2253/1124; B01D 2257/504; B01D 2273/20; B01J 2208/0015; B01J 2208/0038; B01J 2208/00504

(57) ABSTRACT

An autothermal process of concentric bubbling fluid double bed for the production of syngas by gasification with biomass steam, in the presence of a granular material includes: continuous gasification under stationary bed condition of said granular material in bubbling fluidisation regime of biomass with water vapour with thermochemical transformation of the fuel into raw syngas and char, the raw syngas including heavy hydrocarbons in the steam state and any harmful compounds in traces, in a first reaction volume; combustion in bubbling fluidised bed with air of the char and of auxiliary fuel in a second reaction volume; the transfer velocity of the granular material between the first and second reaction volumes being such that the thermal difference does not exceed 20° C.; separation from the raw syngas by hot filters; and elimination of any harmful compounds in traces.

### FIELD

The present invention concerns a system for the production of syngas with high hydrogen content and with medium-high calorific value by thermochemical conversion of biomasses and conditioning composed of high-temperature ceramic filters with catalysts for the simultaneous removal of particulate matter and conversion of tars.

### BACKGROUND

Biomasses (products, by-products and waste from the forestry, agri-food and industrial sectors, as well as the organic fraction of municipal solid waste) are known to represent one of the forms of storage of solar energy in chemical energy, subject to renewal on a much lower time scale than that of the fossil energy sources. Biomasses are the fourth largest energy resource in the world (after oil, coal and natural gas), the theoretical potential thereof is higher than world energy consumption and, being derived from organic substances, can be considered a renewable energy source. For these reasons, the technological challenge regarding biomasses as an energy resource lies in their sustainable use rather than in their availability. In fact, their use is limited by the complexity of the supply chain (often in competition with the main uses of the organic matter, such as food and materials), the low energy density and the high local emissions of pollutants. To really exploit the energy potential of biomass, technologies for the conversion into thermal, electrical energy and biofuels (bio-methanol, bio-methane, hydrogen, etc.) that are reliable (e.g. applicable to different biomasses), have high efficiency and low environmental impact must be developed.

In order for this abundant energy source to be exploited effectively, there is a need for technologies that can convert the solid fuel (biomass) into an energy carrier and for more “manageable” chemical syntheses, for example into synthesis gases (syngas), for example through a gasification process. Gasification is a thermochemical process that allows to convert a solid fuel into a gaseous one (syngas) to be exploited: inside internal combustion engines, micro turbines and in fuel cells, to produce electrical and thermal energy or to produce biofuels and chemicals.

The gasification process has been known since ancient times and can be defined as a combustion process in deficit of comburent. In fact, gasification itself is an overall endothermic process (devolatilization-pyrolysis of the biomass followed by reforming of gases and steams produced), which requires the supply of heat in direct (partial combustion of the biomass itself) or indirect (heat exchange with or without transfer of matter) form. Only in recent decades has it been possible to effectively overcome a series of problems concerning the efficiency in the production of syngases, the reliability and the level of concentration of polluting compounds released into the desired product and into the environment.

In this process, the gasification process has seen the appearance of different types of reactor (gasifier): with fixed bed with flow of the gas produced in updraft and downdraft, entrained bed and fluidised bed. The difference lies in the degree of mobility of the biomass in the reactor (as well as in the range of values of the flow rate of the same supplied to the reactor). In the first case the biomass is stratified constituting a fixed bed, in the second case it forms instead a homogeneous mixture entrained in the ascensional stream of the gas and, finally, in the third case the biomass is “fluidised” together with an inert particle solid kept in suspension inside the gasifier by the flow of the reaction gases.

The plant configurations used to date have multiple weaknesses that technological research is trying to solve. The first problem is represented by the low energy efficiency of the small plants, which today mainly use fixed-bed reactors, less good in terms of energy conversion, both for the lower contact between fuel and comburent, both due to the non-homogeneity of the conversion temperatures inside the reactor, and due to the difficulty in controlling these temperatures, and therefore the instability of operation and the generation of hot spots.

The second problem is represented by the fact that the syngas produced by gasifiers of the updraft type is rich in unwanted substances (mainly particulate matter and condensable heavy hydrocarbons, also called tars) and therefore the reactor must be coupled with conditioning systems, generally in cold mode, which include additional elements in the process line, such as water or biodiesel scrubbers, which entail problems of disposal of polluted water, in the water scrubber, and problems of consumption of biodiesel, in the biodiesel scrubber, and in any case involve additional costs of plant management. The downdraft fixed-bed reactors produce a gas with a low tar content, but they are difficult to scale due to their design (applications with reactors of this type and thermal power higher than MW are very rare) and present non-negligible operating safety problems (possible direct contact between fuel gas and combustion gas). Finally, the fluidised-bed reactors also need external conditioning systems, and their application, particularly on a small scale, entails difficulties in project development and of operation.

To date, the methodologies followed in practice for gasification at small sizes/potentialities are essentially those with a downdraft or updraft fixed bed, which have not been able to efficiently overcome a series of problems related to the low energy yield and to the cleaning of the syngas exiting the reactors. The state of the art is instead oriented towards more efficient fluidised-bed reactors with syngas hot conditioning, which are however only convenient for large sizes, due to the thermal losses that occur in the various parts of the plant. To try to limit the thermal losses in the plants with fluidised-bed reactors, several solutions have been proposed.

For example, US 2004/045272 A1 describes a process and apparatus for effectively exploiting the thermal energy and the oxygen at high temperature of the exhaust gases of an external combustor. In particular, a fluidised medium moves between the gasification reactor and the combustion reactor while the exhaust gas of the external combustor is used as fluidisation gas in the combustion reactor. Also in this case the gasification reactor and the combustion reactor are made as two separate reactors, with inevitable heat losses in the passage from one reactor to another.

US 2006/265955 A1 discloses a method and apparatus for obtaining combustion gases at high calorific value, in which carbonaceous materials are allothermically gasified in a fluidised layer containing solid particles, using a gaseous gasifying agent and by heat supply: the gases thus produced are separated from the solid particles and collected. This method is characterized in that the solid particles are indirectly heated in a first descending bed and are supplied to a second ascending fluid bed where most of the gasification takes place. The apparatus consists of a reactor divided by a wall into two flanked sections in which the fluidised beds are housed: the supply of heat to the gasification takes place through the partition wall which also acts as a heat exchange wall.

KR 101 598 982 B1 discloses a hybrid gasification reactor that combines a fluidised-bed gasification reactor with a high temperature plasma gasification reactor. The hybrid gasification reactor comprises: a first chamber with a double gasification reactor with fluid bed including a drop fluid bed reactor and a boiling fluid bed reactor; a second chamber with a high temperature plasma gasification reactor.

EP 1 043 385 A1 discloses a fuel gasification reactor comprising a fluidised-bed gasification chamber and a fluidised-bed combustion chamber (for combustion of the char generated in the gasification chamber) which are separated by an internal wall which allows recirculation of the fluidizing medium between the two chambers but prevents gases from flowing from one chamber to another.

### SUMMARY

However, none of the fluidised bed gasification reactors described in the prior art can significantly reduce the thermal losses that occur in the various parts of the plant, to such an extent as to make the use of this technology suitable for small or medium-sized plants.

In this context, the present invention comes into play, which proposes to provide a system for the production of syngas with high hydrogen content and medium-high calorific value by thermochemical conversion of biomasses, for applications of chemical transformations of the syngas at high efficiency and low emissions (e.g. production of electrical and thermal energy through high temperature fuel cells; production of biofuels and second generation chemicals, i.e. not from raw materials that compete with food uses, such as lignocellulosic biomasses) with optimal heat recovery and applicable to small-sized plants.

In particular, according to the present invention, the gasification reactor and the combustion reactor are coaxial and with boiling fluidised bed, whereby they have smaller overall dimensions and thermal dispersions compared to the current solutions (separate or non-coaxial or non-circulating fluidised bed reactors) and the gasification reactor is coupled with a “hot” system for the simultaneous dedusting of the raw syngas produced and the conversion of heavy hydrocarbons (tars) into further fuel gas fractions and for the elimination of harmful compounds in traces (H₂S, HCl, alkaline steams). This solution represents an important advance over the state of the art, which instead provides for the cold conditioning of the syngas as it allows to completely eliminate the particulate matter. In fact, using high-temperature ceramic filters totally eliminates the particulate matter at the outlet of the reactor, contrary to what happens using electrostatic scrubbers and precipitators, which have lower removal efficiencies, or to what happens using porous septum filters, which require a preliminary cooling of the gas and a replacement of the septum. Furthermore, through the catalysts placed inside the particulate filters the solution according to the present invention also allows the conversion of the tars. In fact, the most recent targets imposed by the ecological transition envisage diversified uses of the syngas (synthesis of liquid biofuels and chemicals, hydrogen enrichment through the Water Gas Shift process, supply of high-temperature fuel cells), for which it is not only necessary to completely eliminate the particulate matter, to remove the tars and to provide a high-temperature syngas, but it is also energetically advantageous to preserve the thermal and water vapour content of the syngas exiting the gasification reactor.

This invention is composed by:
a two-chamber reactor with coaxial geometry (a gasification/carbonation chamber and a combustion/calcination chamber), both with a bubbing fluidised bed, for the production, from residual biomasses, of syngas with medium-high calorific value (>10 MJ/Nm³) and a high hydrogen content (>30% or >60% if used with sorbent for CO₂) without the use of pure oxygen, with the possibility of having negative CO₂ emissions, as well using a sorbent inside the gasification chamber (which in this case also carries out a carbonation). The char remaining from the gasification chamber is combusted in the combustion chamber (if the sorbent is present in the gasification chamber, passing to the combustion chamber, this sorbent carries out a calcination);
a separate hot conditioning system, consisting of a unit containing ceramic/metallic filters for filtration of the solid particulate matter integrated with commercial or tailor made catalysts for the removal (by catalytic conversion) of the tars from the gaseous flow;
an integrated management and control system for the gasifier and for the coupled air conditioning unit, which allows to obtain: a high chemical and thermal efficiency (temperature homogeneity, conversion of tars into useful gases); a high annual operation with low operating costs, manageable in a different way depending on the different plant using the syngas (no cleaning/conditioning residue, like with the cold methods according to the prior art, since the tar is not separated but transformed); steam/biomass ratio modifiable to have the correct composition of syngas and amount of steam for the downstream system; possible injection of air or enriched air for temperature control in the different parts of the plant, for example in the free section of the reactor placed above the bed (freeboard) and in the tank of the filters; maintenance made easy by the separation of the filtration equipment with respect to the gasifier and by the management of the filtering elements (filtering candles) in clusters (diversified groups), which allows a differentiated use of the different clusters during maintenance.

In particular, according to the invention, the reactor consists of two coaxial chambers with a bubbling fluidised bed that communicate through two siphons to allow the exchange of flows of solid matter and energy without a bypass of the different gas between the two areas minimizing energy losses. This solution is highly functional in terms of scalability of the plant towards small sizes. The continuity between the two chambers allows a very efficient heat exchange between the (exothermic) combustion and (endothermic) gasification processes. This double coaxial chamber avoids in fact the need to realize two separate reactors for combustion and gasification, as is currently the case in the circulating fluidised bed reactors and the fact that they are both with a bubbling bed (therefore with dense beds and smaller freeboards for equal powers) allows greater compactness and lower thermal dispersions.

Therefore, this solution entails both a reduction in the overall dimensions of the plant and in the construction costs.

More in detail, the gasifier consists of a bubbling fluidised bed that works at gasification temperatures (700-90020 C. in case of absence of sorbent for CO₂, 600-700° C. in case of presence of sorbent for CO₂), within which the biomass reacts with the water vapour alone to produce syngas. The combustor, inside which the char coming from the gasifier thanks to the circulation of the solid material between the two chambers, and any auxiliary fuel flow (by way of example LPG or natural gas) are combusted with air, consists of a bubbling fluidised bed arranged internally to the same gasification reactor.

The continuity between the two chambers (gasification and combustion) allows a particularly efficient heat exchange between the (exothermic) combustion and (endothermic) gasification processes: in fact, the thermal transport is based, in addition to the transport of material from one bed to another, also on irradiation, convection and conduction. This configuration allows, therefore, not only an easier recirculation of material, but also the possibility of inserting catalysts and sorbents into the bed for the conversion/capture of CO₂ and of pollutants.

A first specific object of the present invention therefore is an autothermal process by means of a concentric dual bubbling fluidized bed for the production of syngas by means of gasification with biomass steam, in the presence of a granular material, comprising the following steps:
continuous gasification under stationary bed condition of said granular material in bubbling fluidisation regime of biomass with water vapour, at a temperature comprised between 700 and 900° C. and pressure close to the atmospheric pressure, with thermochemical transformation of the fuel into raw syngas and char, said raw syngas comprising heavy hydrocarbons (tars) in the
combustion in bubbling fluidised bed with air of the char and of auxiliary fuel in a second reaction volume; wherein said second reaction volume is a vertical cylindrical volume and said first reaction volume is an annular cylindrical volume external to said second reaction volume, in functional connection (transfer of matter and of heat) with said second reaction volume;
transfer of said granular material from said first reaction volume to said second reaction volume and vice versa, through siphons, maintained in a condition of incipient fluidisation with water vapour; the transfer velocity of said granular material between said first and second reaction volumes being such that the thermal difference does not exceed 20° C., i.e. at a temperature lower than that mentioned in the literature for other embodiments of the double fluid bed technology;
separation from the raw syngas obtained in said step of gasification of the elutriated solid particulate matter entrained by means of hot filters and hot conditioning of the syngas; the hot conditioning comprising the following sub-steps:
   catalytic conversion in the presence of water vapour (steam reforming) of the heavy hydrocarbons (tars) with increase of the fraction of hydrogen and carbon monoxide in the final gaseous product; and
   elimination of any harmful compounds in traces.

In particular, according to the invention, the air flow rate supplied to the second reaction volume, or combustion volume, is adapted to ensure the production of thermal energy necessary for the thermochemical gasification process taking place in the first reaction volume and preferably is comprised between 0.2 and 0.5 times that necessary for the stoichiometric combustion of the entire biomass flow rate (Equivalence Ratio). The separation of the second reaction volume (combustion) supplied and fluidised with air from the first, that is from the one strictly said of gasification, fluidised with water vapour, allows to drastically limit the dilution of the syngas due to the nitrogen initially contained in the air flow rate without having to resort to the use of enriched air or pure oxygen, which would affect the operating costs. The present invention allows to reduce the nitrogen content in the syngas from about 50% (gasification in a single reaction volume) to less than 10%, with greater gasification efficiency, increase of the calorific value of the syngas by more than the double (10-12 MJ/Nm³ dry syngas against 4-5 MJ/Nm³dry syngas with an Equivalence Ratio (ER) comprised between 0.2 and 0.5. With the aforementioned air flow rate, the second reaction volume of the equipment, sized with the specifications of the present invention (combustion volume), allows the complete combustion of the char and of the auxiliary fuel, the latter being equal to about 20% of the total thermal power, defined in relation to the calorific value of the supplied biomass flow rate.

Preferably, according to the invention, the nitrogen content in the syngas obtained from said gasification step is less than or equal to 10% and/or the calorific value of the syngas obtained from said gasification step is comprised between 10 and 12 MJ/Nm³ dry syngas and/or the amount of gasification steam is adapted to guarantee a steam-to-biomass ratio comprised between 0.5 and 1.

In particular, again according to the invention, the cylindrical annular section at the upper surface of the granular bubbling bed of the first volume (the one for the gasification with steam) is sized to guarantee a fluidisation velocity with the steam alone (inlet gaseous flow rate) higher than that of minimum fluidisation (at the operating temperature and pressure conditions of the equipment) and simultaneously is lower than the three times the minimum fluidisation velocity, considering the flow rate and the composition of the exiting gas downstream of the fluidised bed.

Preferably, according to the invention, said auxiliary fuel for combustion in the bubbling fluidised bed with air of the char is obtained from renewable energy resources.

In particular, according to the present invention, the catalytic conversion of said hot conditioning step is preferably carried out at a temperature greater than or equal to 700° C. and more preferably the temperature at which said catalytic conversion is carried out is controlled by injection of pure oxygen or in the form of enriched air and even more preferably the amount of oxygen added by injection is of the order of 10-20 g/Nm³dry syngas.

A second specific object of the present invention is also a system for the production of purified syngas, for energy applications and for secondary chemical transformations, according to the previously defined process, characterized by the combination of a gasification reactor with a system for the hot conditioning of the syngas exiting the gasification reactor, wherein in particular said gasification reactor is divided into two chambers that are partially filled with a granular material and arranged internally to each other, in particular an external gasification chamber (cylindrical ring) and an internal combustion chamber (cylinder), said chambers being separated by a cylindrical separation wall, said gasification chamber comprising one or more biomass inlets and one or more process steam inlets, and a raw synthesis gas outlet, said combustion chamber comprising an air inlet and a combustion gas outlet, said gasification chamber and said combustion chamber being separated by said wall, said wall comprising one or more upper openings, for connecting between said gasification chamber and said combustion chamber, each upper opening being provided with a siphon coupled to an upper fluidisation line with steam, adapted to allow the passage of said granular material and to prevent the passage of gas and one or more lower openings, for connecting between said gasification chamber and said combustion chamber, each lower opening being adapted to allow the passage of said granular material and of char and being coupled to a lower fluidisation line with steam; wherein the minimum passage section of said lower opening has a surface substantially equal to the passage section in the upper siphons and has an amplitude such as to guarantee the movement of char with dimensions equal to or greater than those of the biomass.

Preferably, according to the invention, the biomass is supplied in granules, with a maximum equivalent diameter equal to 35 mm.

In particular, according to the present invention, said system for the hot conditioning of the syngas exiting the gasification reactor consists of a vessel with a series of high-temperature ceramic or metal filtering candles, filled with Ni-based catalyst or noble metals. The activity of these catalysts (with reference to those available on the market) is conditioned by the temperature, which must be greater than or equal to 800° C.; to guarantee this temperature, therefore, an injection of oxygen (pure or in the form of enriched air) of the order of 10-20 g/Nm³_{dry syngas} is provided, even for small-sized applications (100 KWth of total thermal power).

Preferably, again according to the invention, said filtering candles have a cylindrical configuration, the catalyst being arranged according to an annular geometry.

Furthermore, according to the present invention, the system for the production of syngas preferably comprises a cyclone and a torch, which are positioned downstream of said gasification reactor and upstream of said system for the hot conditioning of the syngas exiting the gasification reactor.

Still according to the invention, said gasification reactor may comprise an inlet for a start-up burner.

Finally, according to the present invention, said granular material may consist of a solid sorbent for the capture of CO₂.

### BRIEF DESCRIPTION OF THE FIGURES

The present invention will now be described by way of non-limiting illustration according to a preferred embodiment thereof, with particular reference to the figures in the appended drawings and the examples, wherein:

FIG. 1 shows a flow diagram of a pilot plant relating to the system for the production of syngas according to the present invention,

FIG. 2 shows a functional diagram of the gasifier of the pilot plant of FIG. 1,

FIG. 3 shows a diagram in exemplary form of the system for the hot conditioning and cleaning of the raw synthesis gas of the pilot plant of FIG. 1,

FIG. 4 shows a diagram in exemplary form of a filtering candle of the system for the hot conditioning and cleaning of the gas of the pilot plant of FIG. 1,

FIGS. 5a-5d show side views and a plan view of the gasifier of the pilot plant of FIG. 1,

FIG. 6 shows a detail of the lower section of the gasifier of the pilot plant of FIG. 1,

FIG. 7 shows a diagram of the variation in time of the temperature of the gasifier of the pilot plant of FIG. 1, during the start-up step and during an exemplary test, and

FIG. 8 shows a perspective view of a filtering candle of the system for the hot conditioning and cleaning of the gas of the pilot plant of FIG. 1, filled with pellet catalyst.

### DETAILED DESCRIPTION OF THE EMBODIMENTS

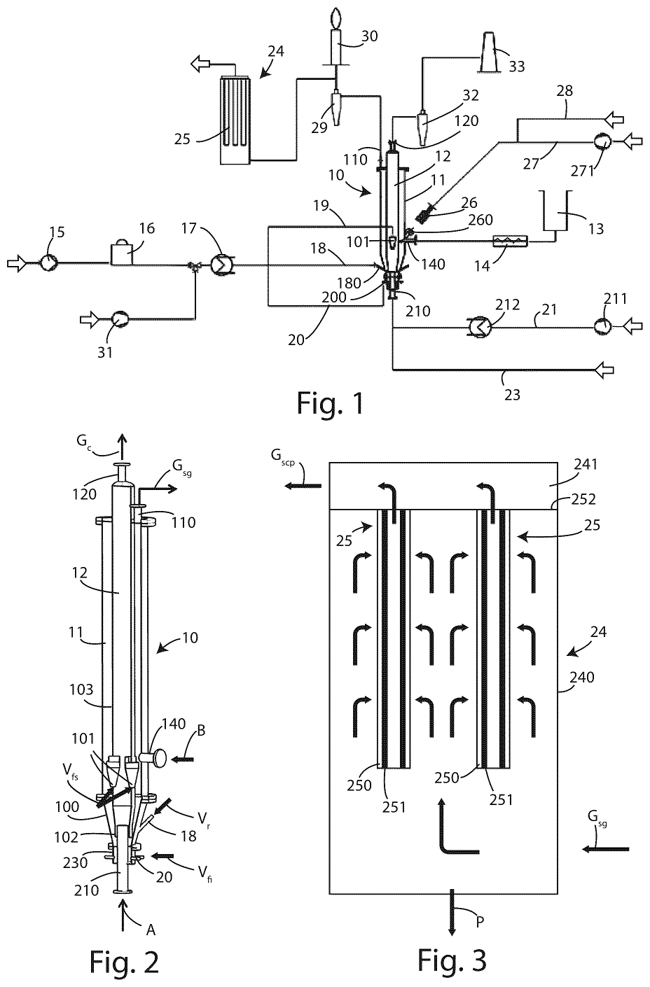

Referring to FIG. 1, the system for the production of syngas with high hydrogen content and medium-high calorific value by thermochemical conversion of biomasses according to the present invention comprises: a two-chamber reactor 10, in particular a gasification chamber 11 (hereinafter also referred to as a gasifier 11) and a combustion chamber 12 (hereinafter also referred to as a combustor 12), the combustion chamber 12 being arranged internally to the gasification chamber 11.

The gasifier 11 is supplied with biomass (the incoming biomass being indicated with reference B in FIG. 2) and steam (Vₚ in FIG. 2). The system for supplying the biomass B comprises an inlet 140 connected to a loading hopper 13 and to a two-screw conveyor 14. The hopper 13 and the conveyor 14 are sized according to the potential required by the plant which, by way of non-limiting example, can be comprised between 20 and 2000 kg/h of incoming biomass (0.1-10 MWth). The steam supplying system comprises a water supply pump 15, a steam generator 16, and an electric heater 17 for steam overheating. The steam is supplied to the reactor 10 through a process steam supply line 18, as well as through two fluidisation lines, respectively a fluidisation line of the upper siphon 19 and a fluidisation line of the lower siphon 20, as will be better illustrated below with reference to FIG. 2.

The combustor 12 is supplied through an air inlet 210 connected to a supply line 21 for the supply of air coming from a blower 211 and heated by an electric resistance heat exchanger 212.

The air and the steam enter the reactor at temperatures comprised between 200 and 450° C.

The supply system of the combustor 12 also comprises an auxiliary line 23, connected to the inlet 210, to allow the supply into the combustor 12, together with the process air, of also the auxiliary fuel (such as by way of example LPG or natural gas), if necessary, to help support in addition to the char the endothermic gasification reactions.

By way of example, the gasifier 11 can operate at a temperature comprised between 700 and 900° C. The flow rate of the air at the inlet to the combustor 12 can be varied, depending on the process conditions, to ensure an Equivalence Ratio (ER) that is variable between 0.2 and 0.5. The inlet steam, on the other hand, can be varied to obtain a steam/biomass ratio (S/B) comprised between 0.5 and 1, also depending on the operating conditions and the quality of the gas to be obtained.

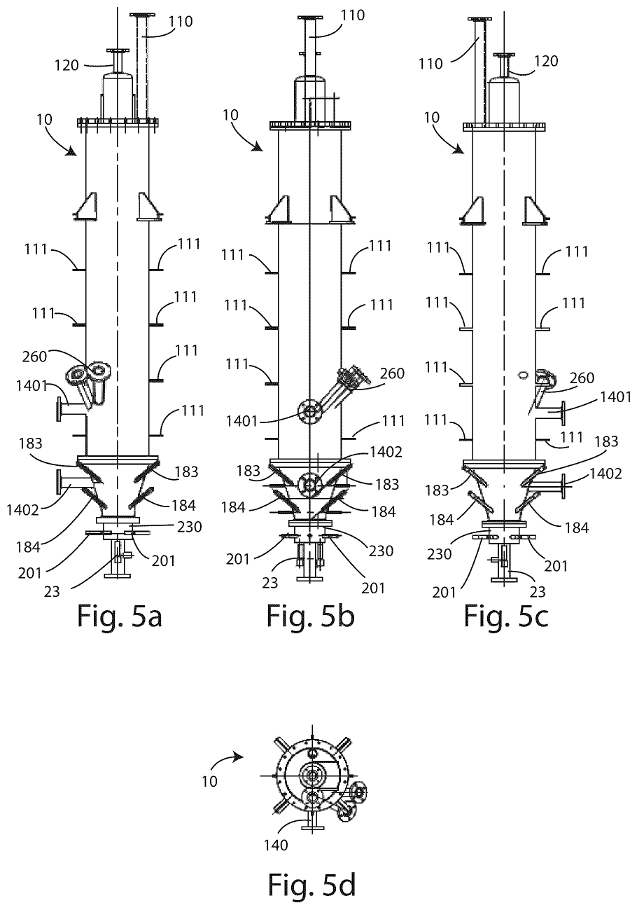

To ensure high temperatures in the area placed above with respect to the bed of the gasifier, nozzles (shown in FIGS. 5a-5d with reference numeral 111) are provided in the freeboard of the gasification chamber 11 in order to perform controlled injections of air or enriched air, as will be explained in greater detail in the description of the gasifier with reference to FIG. 2. To facilitate start-up, the reactor 10 is further provided with an inlet 260 for a start-up burner 26, supplied with air via an auxiliary line 27, provided with blower 271, and with a fuel, for example LPG, supplied via an auxiliary line 28.

The raw synthesis gas G_{sg} exiting the gasifier 11, containing tar and particulate matter, passes through the outlet line 110 through a conditioning system consisting of a cylindrical vessel 24 in which a series of high-temperature ceramic or metal filtering candles 25 are housed, inside which a catalyst based on Ni or noble metals is provided; the candles act simultaneously for the removal of the particulate matter, thanks to their porous structure, and for the conversion of the tars and possibly of methane, thanks to the internally housed catalyst. The number and the sizes of the filtering candles 25, as well as the amount and quality of the catalysts, depend on the needs of the downstream gas-using systems. The operating temperature (of both the gasifier 11 and of the air conditioning system) is chosen according to the needs of the downstream systems, especially according to the concentration of tars tolerated by the components that will use the syngas, and to the concentrations of hydrogen and methane desired. For example, if a hydrogen-rich gas is required, with methane and tar concentrations close to zero (e.g. for the use of synthesis gas in SOFC) temperatures greater than 800° C. in both the gasifier and the conditioning system must be ensured, so as to favour endothermic steam reforming reactions of tar and methane. In the case in which it is preferable to maintain relevant methane concentrations (for example for the use of the syngas in biomethane synthesis reactors or internal combustion engines), the air conditioning system will be operated at temperature below 800° C., using catalysis based on noble metals.

Furthermore, upstream of the conditioning system, there are a cyclone 29, for the separation of coarser solid particles and a torch 30, to which the gas exiting the gasifier 11 is conveyed in the start-up step, during which, in order to bring the reactor to the operating temperatures, air is sent into the gasifier 11 through the blower 31, which air is pre-heated by the electric resistance heat exchanger 17.

Finally, the flow of combustion fumes G_{c} coming from the combustor 12 through the exhaust line 120, is sent to a cyclone 32, for the separation of the solids and is then conveyed to a vent 33.

The characteristics of the gas obtainable from the gasification unit according to the present invention are shown, by way of non-limiting example, in the following table 1.

TABLE 1

| | |
|---|---|
| Gas yield | 1-1.7 |
| (Nm³_{(dry)}/kg_{biomass}) | |
| H₂ (% dry vol.) | 30-88 |
| CO (% dry vol.) | 5-35 |
| CO₂(% dry vol.) | 5-25 |
| CH₄(% dry vol.) | 2-15 |
| Tar (g/Nm³) | 0-1 |

The maximum hydrogen value can be achieved by integrating the gasification with steam with the capture of CO₂ through sorbents (such as CaO) used as material of the bed of the reactor.

FIG. 2 shows in detail the reactor 10 consisting of the two concentric cylindrical chambers.

The two chambers are fluidised at different speeds. In particular, by way of non-limiting example of the present invention, the fluidisation velocity of the gasification chamber 11 (external cylinder) is equal to 1-2 u_{mf} (i.e. between 1 and 2 times the minimum fluidisation velocity), the chamber can therefore be defined as a slow chamber, while the fluidisation velocity of the combustion chamber (internal cylinder) is equal to 3-10 u_{mf}, the chamber can therefore be defined as a fast chamber. Consequently, the material of the bed of the combustion chamber 12, fluidised with air A through the inlet 210, expands more than that of the gasification chamber 11, fluidised with process steam Vₚ entering through the process supply line 18, allowing the material of the fluid bed to overflow from the combustion chamber 12 to the gasification chamber 11 through two upper siphons 101 maintained in the fluidisation regime with steam V_{fs} supplied through an upper fluidisation line (indicated in FIG. 1 with the reference numeral 19) at a velocity equal to 1-2 u_{mf}. The presence of the siphons on the separation wall of the two chambers therefore allows the passage of material of the bed between the combustion chamber 12 and the gasification chamber 11, with consequent heat exchange between the two chambers, however avoiding the occurrence of unwanted gas leaks between the two chambers.

Conversely, the material of the fluidised bed of the gasification chamber 11, together with the unreacted char, passes from the gasification chamber 11 to the combustion chamber 12 through a lower orifice 102, fluidised with steam V_{fi} (at a velocity equal to 1-2 u_{mf}) through a lower fluidisation line 20, so as to also act as a “siphon”.

The configuration described allows the recirculation of granular material between the two chambers. This material acts as a thermal carrier between the two chambers, supporting the endothermic process of gasification with steam through the heat transferred thanks to the material of the bed that has been heated in the exothermic combustion process, without the syngas G_{sg} of the gasifier 11 being mixed with the combustion fumes G_{c} coming from the combustion chamber 12. The cylindrical wall 103 separating the gasification chamber 11 from the combustion chamber 12 allows further heat exchange between the two chambers through a mechanism of heat transfer by conduction and irradiation, reducing the amount of material of the fluid beds to be recirculated by an amount equal to 20-30% compared to that necessary in the fluidised dual bed systems according to the prior art.

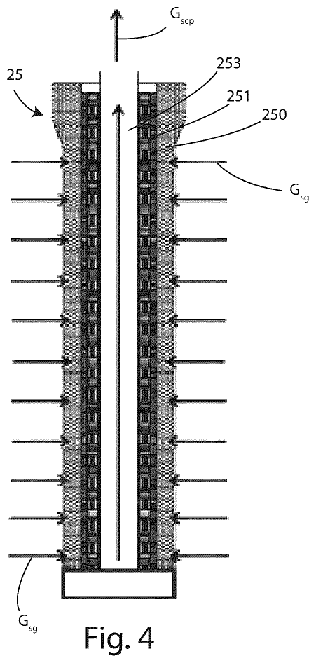

Referring to FIGS. 3 and 4, in which the system for the hot conditioning and cleaning of the raw syngas G_{sg} exiting the gasifier 11 is shown, this is composed of a cylindrical vessel 24 inside which a series of filtering candles 25 made of porous material of a ceramic or metallic nature are housed, for the hot removal of the particulate matter P, which is filtered by the porous structure of the candle and subsequently accumulates on the bottom of the vessel 24, from where it can be extracted. The internal cavity of the filtering candles 25 can be partially filled with pellet catalyst, however leaving an internal cavity for the passage and the exit of the gas from the top of the filter, thus creating a catalytic “layer” 251 for the conditioning of the gas. Inside and over the entire length of the filtering candles 25, a cylindrical porous septum 253 is inserted, made of the same material as the candle 250 for the confinement of the catalyst in the peripheral part of the internal cavity of the candle.

As shown in FIG. 3, the raw syngas G_{sg} coming from the gasifier 11 enters from the lower section of the vessel 24, and is filtered by the porous structure of the candle, which allows the passage of the private gaseous phase of the particulate matter that remains in the external part of the candle. Subsequently, the gas continues to flow in a radial direction towards the inside of the candle, encountering the catalyst layer 251 placed inside the filtering candles, which favours the steam reforming reactions of the tar and of the methane contained in the syngas. In this way the heavy hydrocarbons, harmful to the downstream components, are converted into H₂ and CO that enrich the syngas. The conditioned and purified syngas G_{scp} flows towards the outlet section of the tank 24.

The filtering candles with integrated catalyst are therefore able to perform a dual function, removing the particulate matter and converting the tars into a single component.

### EXAMPLE 1

FIGS. 5a-5d show in greater detail the design of a gasifier 11 for 20 kg/h of biomass at the inlet (0.1 MWth). Of course, the sizes of the reactor 10 may vary depending on the inlet flow rate of biomass B, but the structure will remain unchanged. By way of example, the data relative to a 0.1 MWth gasifier are shown below.

In order to be able to reduce the lower fluidisation steam flow rate V_{fi} to be sent to the lower siphon 102 and the amount of material used in the bed (about 90 kg of granular material with d₃₂=500 μm), the lower section (indicated in FIG. 1 with the reference numeral 100) of the reactor 10 is truncated conical, with an inclination of about 73° with respect to the horizontal. Such inclination of the lower section 100 of the reactor 10 ensures that the material of the bed of the gasifier 11 can be easily conveyed towards the lower siphon 102 (and therefore towards the combustor 12), regardless of the fluidisation state of the bed. The inserted amount of material of the bed must in any case guarantee a static bed height of about 0.80 m starting from the inlets of the lower siphon 102 and must not in any case submerge the “glass” of the upper siphon 101.

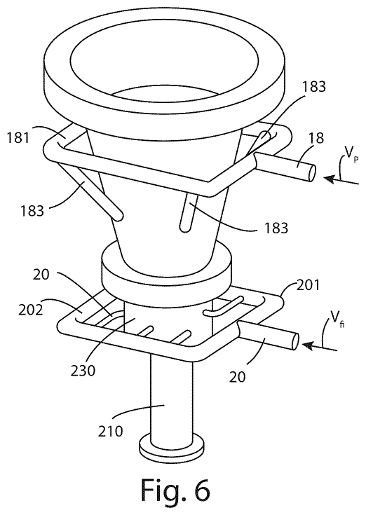

As shown in FIGS. 5a-5d and FIG. 6, to ensure an even distribution in the inlet, the process steam Vₚ (in the example in amounts equal to 10-20 kg/h) can be introduced through two sets of nozzles arranged along the cylindrical surface of the gasifier 11 supplied by collector tubes called “crowns” (respectively an upper crown, indicated in FIG. 6 with the reference numeral 181 and a lower crown not shown in the figures), each provided with four ½″ inlet tubes (respectively four upper inlet tubes 183 and four lower inlet tubes 184), inclined by 39° with respect to the horizontal. The inclination of the upper inlet tubes 183 and of the lower inlet tubes 184 makes it possible to avoid their filling with material of the bed and their clogging. The location in height and along the truncated conical surface of the lower section 100 of the reactor 10 allows an even distribution of the process steam in the reactor 10.

In addition, as shown in FIG. 6, in order to be able to ensure an even distribution of the steam, the entry of the flow V_{fi} for the fluidisation of the lower siphon (2-5 kg/h) is guaranteed by six horizontal (½″) sections of tube 201, placed equidistant from each other along the external surface of the lower cylinder 230 of connection between the inlet 210 and the combustor 12 and connected via the collector tube 202 to the lower fluidisation line 20.

The reactor 10 further provides two inlets for the biomass B at different heights, respectively an upper inlet 1401 and a lower inlet 1402. The upper inlet 1401 supplies biomass above the free surface of the fluidised bed (>0.8 m), while the lower one supplies the biomass directly into the fluidised bed (at 0.3 m). Depending on the material to be gasified, it may be more convenient to use either inlet for the solid fuel.

In the freeboard at different heights, four ½″ sections of tube 111 are provided for each height, to be used as sampling points, for the insertion of probes or for the introduction of process fluids, for example to introduce small flow rates of air or enriched air if it is necessary to increase the temperature in the freeboard compared to that of the bed.

A typical practical example of the need for the increase in temperature occurs when biomasses have to be gasified with very low ash melting temperature (such as straws). In this case, the gasification temperature in the bed must be limited to, for example, 700-750° C. The concentration of tars generated at these temperatures would be excessive (10-100 g/Nm³) and the injection of small amounts of enriched air into the freeboard (1-2 kg/h), burning a small fraction of produced gas, allows to obtain an increase in temperature (850-900° C.) in this area, so as to greatly increase the primary conversion of tars in the gasifier 11, and to guarantee more suitable temperatures and concentrations of tars, for an effective use of the downstream conditioning system, consisting of candles with catalytic filling (T>800°0 C., concentrations=1-10 g/Nm³). The same injections of air or enriched air can be used to compensate for the inevitable outward heat losses that occur in this area of the reactor, thus ensuring process temperatures that are close to, if not higher than, those of the bed itself (≥850° C.), making the catalytic conditioning system downstream of the gasifier 11 more effective.

Referring to FIG. 1, the start-up system of the gasifier 11 provides a 20 KW start-up burner 26 (supplied with air and LPG or natural gas) placed above the bed, with an inlet 260 inclined by 45° pointing towards the bed itself and towards the inlet 140 of the biomass B, in particular with reference to FIGS. 5a-5d, towards the upper inlet 1401 of the biomass B placed above the bed.

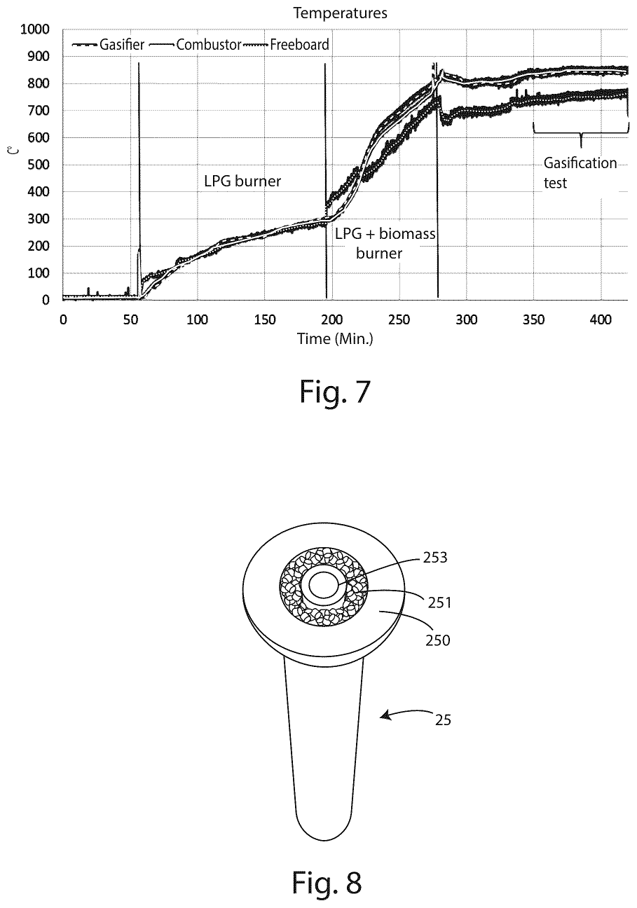

Finally, with reference to FIG. 7, the temperatures measured over time (on the axis of the abscissa) during the start-up step and during an exemplary test are shown on the ordinates.

In the first start-up step (between minutes 60 and 200) both the gasifier 11 and the combustor 12 were supplied with pre-heated air (200-30020 C.). In this step, the start-up burner 26 was also switched on, to increase the temperature of the bed with a heating velocity equal to 2-3° C./min. During heating, the air flow rates sent (both in the gasifier 11 and in the combustor 12) were those necessary to guarantee a superficial velocity higher than that of minimum fluidisation. With the increase of the temperature of the gasifier 11, the air flow rates have been decreased, but they have still been maintained such as to guarantee a bubbling bed regime both in the gasification chamber 11 and in the combustion chamber 12.

In the specific case subject-matter of this example, with a 0.1 MWth gasifier, the combustor 12 was started with an air flow rate equal to 40 kg/h at room temperature, to gradually reach 30 kg/h at 300° C. These conditions in the combustor 12 were subsequently kept unchanged, being 30 kg/h the air flow rate necessary to guarantee a fluidisation velocity with a velocity equal to 5-10 times the u_{mf} at the process temperature (≥800° C.). Still with reference to this example, the gasifier 11 was started with an air flow rate equal to 140 kg/h at room temperature until it reached 80 kg/h at 300° C., and was subsequently kept unchanged. Once the temperature of 300° C. was reached, the supply of biomass B was started in the gasifier 11 with a flow rate of 10 kg/h, so that the combustion thereof contributed to the increase in the temperature of the reactor. The air flow rate introduced into the gasifier 11 for start-up, equal to 80 kg/h, allowed the combustion of 10 kg/h of biomass supplied with slight excess of air (10-20%). Although, in most cases, the temperature of 300° C. is not sufficient to allow the biomass to self-ignite, this ignition is still guaranteed by the start-up burner 26 pointing towards the bed and in particular towards the upper inlet 1401 of the biomass. From this point onwards, the temperature of the bed begins to rise at a rate of about 6° C./min due to the contribution of the start-up burner 26 and of the biomass B supplied. Upon reaching the temperature of about 830° C., it is possible to switch off the start-up burner 26, interrupt the flow of biomass B and switch the gas entering the gasifier from air to steam, with the flows set according to the operating conditions envisaged for the test. After a few minutes necessary for steam stabilization, the biomass is introduced again into the gasifier at the desired mass flow rate and the gasification test is started.

During the test, the gas flow to the combustion chamber 12 is air, like in the start-up step. A flow of LPG, as an auxiliary fuel in addition to the recirculation char, is also supplied into the combustion reactor 12 to provide the heat necessary to support the endothermic gasification reactions.

During the gasification test, in relation to FIG. 7 started approximately at minute 350, the temperatures are approximately constant, which means that the auxiliary fuel flow (LPG) and the char recirculated in the combustor are sufficient to provide the necessary heat for the endothermic gasification reactions. The stable temperature regime in the reactor 10 is proof of the fact that with these process parameters the gasification is autothermal.

Table 2 shows the results obtained using hazelnut shells as incoming biomass, according to the test operating procedures described above.

### See Table

TABLE 2

| | |
|---|---|
| Biomass (kg/h) | 15 |
| Process steam (kg/h) | 10 |
| T̅ gasifier (° C.) | 846 |
| T̅ combustor (° C.) | 849 |
| η_{gas} (Nm³/kg) | 1.2 |
| H₂ (% dry vol) | 34.5 |
| CO (% dry vol) | 23.4 |
| CO₂ (% dry vol) | 18.9 |
| CH₄ (% dry vol) | 9.3 |
| Tar content (g/Nm³) | 12.3 |
| LHV (MJ/Nm³) | 12.6 |
| CGE (%) | 77 |
| Conversion of C (%) | 82 |

The acronym LHV indicates the lower heating value, while the acronym CGE (Cold Gas Efficiency) indicates the percentage of chemical energy contained in the produced gas with respect to the energy provided in input, that is, the one contained in the solid biomass plus the one provided with the auxiliary fuel.

From the evidence that the temperatures in the combustor 12 are very similar to those in the gasifier 11, it can be seen that the circulation system of the material of the bed and the transmission of the heat by means of the cylindrical surface interposed between the gasifier 11 and combustor 12 are extremely efficient.

As a further application example, the system for cleaning and conditioning the gas at high temperature is described, to be integrated with the 0.1 MWth gasifier 11 described above. In particular, six alumina filtering candles (of the UHT type, i.e. of the type suitable for particularly high temperatures), supplied by Pall Filtersystems GmbH, one of which is shown in FIG. 8, were used. Each candle has a length equal to 1.5 m, an outer diameter of 0.06 m and an inner diameter of 0.04 m. The number of candles was chosen in such a way that, by sending all the syngas produced to the conditioning system, a filtration velocity at the process temperature (800° C.) of about 90 m/h, recommended by the supplier of the candles themselves, could be obtained and to obtain pressure losses of less than 30 mbar (in the absence of solid deposits on the external surface of the candles). Referring to FIG. 8 and as described above, inside each candle 25 there is housed a porous septum 253 also made of ceramic material (also supplied by Pall Filtersystems GmbH) with outer diameter 0.02 m and inner diameter 0.01 m, and of the same length as the candle 25. The internal cavity of the candle, delimited by the porous septum 253, is filled with catalyst pellets 251. In the specific case of the example, the catalyst used in the test is a conventional nickel-based catalyst. As already explained, the type of material of the candle 25, as well as the catalyst 251 used may vary depending on the required process conditions and available materials.

Table 3 shows the composition values of the gas exiting the system for cleaning and conditioning the gas at high temperature integrated with the 0.1 MWth gasifier 11 described above, with an inlet temperature of 830° C.

TABLE 3
Exiting gas data

| | |
|---|---|
| H₂ (% dry vol.) | 46 |
| CO (% dry vol.) | 34 |
| CO₂(% dry vol.) | 18 |
| CH₄(% dry vol.) | 2 |
| Tar (g/Nm³) | 0.5 |
| Tₒᵤₜₗₑₜ (° C.) | 778 |

The present invention has been described, in an illustrative but non-limiting manner, according to preferred embodiments thereof, but it is to be understood that variations and/or modifications may be made by those skilled in the art without thereby departing from the relative scope of protection, as defined by the attached claims.

1-19. (canceled)

20. An autothermal method by means of concentric bubbling fluid double bed for the production of syngas by gasification with biomass steam, in the presence of a granular material, the autothermal method comprising the following steps:
continuous gasification under stationary bed condition of said granular material in bubbling fluidisation regime of biomass with water vapour, at a temperature between 700 and 900° C. and pressure close to the atmospheric pressure, with thermochemical transformation of the fuel into raw syngas and char, said raw syngas comprising heavy hydrocarbons (tars) in the vapor state and any harmful compounds in traces, in a first reaction volume;
combustion in bubbling fluidised bed with air of the char and of auxiliary fuel in a second reaction volume; wherein said second reaction volume is a vertical cylindrical volume with a cylindrical wall and said first reaction volume is an annular cylindrical volume external to said second reaction volume and separated from said second reaction volume by means of said cylindrical wall, said first reaction volume being in functional connection with said second reaction volume;
transfer of said granular material from said first reaction volume to said second reaction volume and vice versa, through siphons maintained in a condition of incipient fluidisation with water vapour; said granular material acting as a thermal carrier between said first and second reaction volumes;
transfer of heat from said first reaction volume to said second reaction volume and vice versa by means of conduction and irradiation through said cylindrical wall;
separation from the raw syngas obtained in said step of gasification of the solid particulate matter entrained by hot filters and hot conditioning of the syngas; the hot conditioning comprising the following sub-steps:
catalytic conversion in the presence of water vapour of the heavy hydrocarbons with an increase of the fraction of hydrogen and carbon monoxide in the final gaseous product; and
elimination of any harmful compounds in traces.

21. The method for the production of raw syngas according to claim 20, wherein the transfer velocity of said granular material between said first and second reaction volumes being such that the thermal difference does not exceed 20° C.

22. The method for the production of raw syngas according to claim 20, wherein the air flow rate supplied to the second reaction volume is comprised between 0.2 and 0.5 times that necessary for the stoichiometric combustion of the entire biomass flow rate.

23. The method for the production of syngas according to claim 20, wherein the calorific value of the syngas obtained from said gasification step is greater than 10 MJ/Nm³ dry syngas.

24. The method for the production of syngas according to claim 20, wherein the amount of gasification steam is adapted to guarantee a steam-to-biomass ratio comprised between 0.5 and 1.

25. The method for the production of syngas according to claim 20, wherein the fluidisation velocity with steam alone is higher than that of minimum fluidisation at the operating temperature and pressure conditions of the equipment and is lower than three times the minimum fluidisation velocity, considering the flow rate and the composition of the exiting gas downstream of the fluidised bed.

26. A system for the production of purified syngas, for energy application and for secondary chemical transformations, according to the method of claim 20, comprising a combination of a gasification reactor (with a system for the hot conditioning of the syngas exiting the gasification reactor.

27. The system for the production of syngas according to claim 26, wherein said gasification reactor is divided into two chambers partially filled with a granular material and arranged internally to each other, in particular an external gasification chamber and an internal combustion chamber, said chambers being separated by a cylindrical wall, said gasification chamber comprising one or more biomass inlets and one or more process steam inlets, and a raw synthesis gas outlet, said combustion chamber comprising an air inlet and a combustion gas outlet (120), said gasification chamber and said combustion chamber being separated by said cylindrical wall, said cylindrical wall allowing heat transfer from said combustion chamber to said gasification chamber through conduction and irradiation, said cylindrical wall comprising one or more upper openings, for connecting between said gasification chamber and said combustion chamber, each upper opening being provided with a siphon coupled to an upper fluidisation line (19) with steam, adapted to allow the passage of said granular material and to prevent the passage of gas and one or more lower openings, for connecting between said gasification chamber and said combustion chamber, each lower opening being adapted to allow the passage of said granular material and of char and being coupled to a lower fluidisation line with steam; wherein the minimum passage section of said lower opening has a surface substantially equal to the passage section in the upper siphons; said granular material acting as a thermal carrier from said combustion chamber to said gasification chamber.

28. The system for the production of syngas according to claim 27, wherein the biomass is supplied in granules with a maximum equivalent diameter equal to 35 mm.

29. The system for the production of syngas according to claim 26, wherein said system for the hot conditioning of the syngas exiting the gasification reactor comprises of a tank with a series of ceramic or metal high-temperature filtering candles, filled with Ni-based catalyst or noble metals.

30. The system for the production of syngas according to claim 29, wherein said filtering candles have a cylindrical configuration, and the catalyst is arranged according to an annular geometry.

31. The system for the production of syngas according to claim 26, wherein the system further comprises a cyclone and a torch, which are positioned downstream of said gasification reactor and upstream of said system for the hot conditioning of the syngas exiting the gasification reactor.

32. The system for the production of syngas according to claim 26, wherein said gasification reactor comprises an inlet for a start-up burner.

33. The system for the production of syngas according to claim 26, wherein said granular material comprises a solid sorbent for the capture of CO₂.
